(19) United States
(12) Patent Application Publication
(10) Pub. No.: US 2023/0061500 A1
(43) Pub. Date: Mar. 2, 2023

(54) Adhesive Composition

(71) Applicant: Arthur Imparato, Sao Paulo (BR)

(72) Inventor: Arthur Imparato, Sao Paulo (BR)

(21) Appl. No.: 17/789,354

(22) PCT Filed: Dec. 28, 2020
(86) PCT No.: PCT/BR2020/050633

§ 371 Date: Jun. 27, 2022

(30) Foreign Application Priority Data
Dec. 27, 2019 (BR) 10 2019 028094-8
Dec. 28, 2020 (BR) 10 2020 026736-1

(51) Int. Cl. C09J 133/14

(52) U.S. Cl. CPC C09J 133/14

(57) ABSTRACT

An adhesive composition of general use is described, and particularly suitable for welding plastic parts, in the form of a two-component composition. The first of the two components being a cyanoacrylate based glue, and the second of the two components includes a blend, in powder form, of a polymeric origin component and an organic origin component.

### CROSS-REFERENCE TO RELATED APPLICATIONS

This application is the United States national phase of International Application No. PCT/BR2020/050633 filed Dec. 28, 2020, and claims priority to Brazilian Patent Application Nos. 10 2019 028094-8 filed Dec. 27, 2019 and 10 2020 026736-1 filed Dec. 28, 2020, the disclosures of which are hereby incorporated by reference in their entirety.

### BACKGROUND OF THE INVENTION

### Field of the Invention

The object of the present invention is a two-component adhesive composition intended for the repair of parts in general, and more in particular for joining and filling damaged areas of broken parts and/or that show some loss of material. The present two-component composition has particularly advantageous application in plastic parts repair and recomposition operations.

### Description of Related Art

Modernly, the use of plastic parts has been increasing in the industrial, commercial and residential sectors, either because of the ease of injection, or because of the wide range of polymeric materials available, resulting in an infinite possibility of physical and structural characteristics. For such plastic parts. Polymers currently known, such as polyethylene (PE), polystyrene (PS), polyethylene terephthalate (PET), ABS, polypropylene (PP), just to name the most common, are regularly used in everyday life, each according to with the desired properties for the final product.

It is not uncommon for composite polymers to be used, which are obtained from the combination of two, and possibly more, monomers in order to result in parts with even more particular characteristics. It is not uncommon for modern objects to employ particular combinations of plastic and non-plastic materials.

In the opposite direction and as a result of this technological direction, problems related to the disposal and recycling of such parts arise. The parts obtained from composite polymers are difficult to recycle, precisely because of their non-homogeneous nature, which complicates the reuse of their material. On the other hand, large-volume and high-cost parts also present operational problems for recycling, as they demand an entire appropriate infrastructure aimed at operationalizing the collection, transport and treatment due.

Obviously, such problems could be partially solved by reusing such parts, increasing their useful life and, therefore, avoiding their premature disposal. Nowadays, it is not uncommon to detect the disposal of an entire device due to compromised structure or external parts due to lack of spare parts or, as more usual, due to their prohibitive cost in relation to the total cost of the device. Regarding automotive parts, in particular those with high added value (e.g., for shocks, fairings, optical groups and the like, whose cost can reach several thousand reais), their recycling imposes arduous logistical issues. The alternative concerning the reuse of the damaged part, mainly via the repair of the part in the mechanical workshop, is a much more logical, economically viable and environmentally consistent solution, providing greater profitability to the workshops.

There are some products on the market for the repair of broken parts, which are intended to join, or weld, the broken parts, thus allowing the damaged part to be used again. Among these, and probably the best known, is the cyanoacrylate based glue, with several brands available to the public, and whose propaganda motto is focused on the possibility of gluing a multitude of materials, including plastics. There are still some specific products, for plastics, metal parts and/or specific parts, but these have a limited use.

In general, an inherent characteristic of such general-purpose “glues” is the loss of plasticity and/or malleability of repaired parts, specifically in repaired areas. Thus, and for some specific parts, such as bumpers, any repair can only be considered as efficient and effective if the repair methodology allows the structural and functional characteristics of the same to be recomposed, or at least approximate.

### SUMMARY OF THE INVENTION

Thus, a first objective of the invention is a composition capable of repairing damaged parts in general, in order to restore not only their structure, but also their functional characteristics arising from the malleability and plasticity of the repaired part.

These and other objectives are achieved from a two-component type composition. The first of the two components is a cyanoacrylate based glue. The second of the two components is a powder blend of polymeric origin components and organic origin components.

The object of the invention will be better understood from the following detailed description, given by way of illustration and not limitation, of its preferred embodiments.

### DESCRIPTION OF THE INVENTION

As said, the present composition is defined by two individual two-components, which are applied and mixed directly on the damaged area.

The first of the two-components, with an aggregator and integrator objective, is a cyanoacrylate based glue. For the purposes of the invention, such first two-component can be selected among the glues commercially available on the market, provided that they have an acrylic base and that they are activated in the presence of oxygen (air). In addition, said cyanoacrylate two-component must have low viscosity, in order to assimilate the other components more easily, causing a natural, full and immediate mixture, without effort, pressure or compression at room temperature.

The second of the two-components comprises a mixture or blend of materials, called filling, since they are intended not only to unite the damaged parts of the damaged parts, but also to recompose missing parts and parts removed when the part is repaired.

Said second two-component, or blend, is presented in the form of a mixture of dry or substantially dry powders, comprising organic origin components and inorganic origin components.

Among the inorganic components, elastomer powders or elastomeric polymers, including natural or synthetic rubbers, are particularly suitable. Despite the powders used may come from virgin rubbers, the present composition is equally suitable for the use of materials such as recycled rubbers or elastomers, thus contributing to the reuse of discarded elastomeric materials within the general spirit of the invention.

Among the inorganic components, materials such as plastic polymers can also be used additively, in the form of powders, and selected from a wide range of plastic materials, such as ABS, PE, PS, PET, PP and others. As in the case of elastomeric materials, plastic polymer powders can be virgin, but the best direction of the invention advocates the use of recycled plastic materials. When present, plastic polymer materials are blended, or blended, with elastomeric materials in varying amounts.

Complementing the blend of powders, an organic component is also foreseen, which is formed from one or more organic materials, also in powder, with low relative humidity and comprising organic alloy materials, in addition to organic fiber materials.

Among the organic polymeric alloy materials, gluten is particularly suitable for use in the invention, because its polymeric composition includes gliadin and glutemin. Gluten sources suitable for use in the present invention, such as organic binding material, polymeric fibers, which are present in flours in general, in particular in wheat or corn flour, in addition to cornmeal, cassava flour, etc.

Among the organic fiber materials, cellulose, also a polymer, is particularly advantageous for the purposes of the invention because it is a long chain of glucose, responding very well to cyanogenic interactions (after mixing with the first two-component, the cyanoacrylate based glue), resulting in cyanogenic glycosides. In this sense, starch is also an important source to be considered, since it comes from the organic synthesis of glucose and therefore able to provide the organic component of the alloy, according to the invention.

In this way, and despite the possibility of using individual elements such as the sources of alloy organics and organic fibers, wheat flour is preferably used as a common source of such component organic elements, since it gathers most of them and is of low cost, having high integrative power.

TABLE 1
Composition of the p/p powder blend (second Two-component)

| | Origin | Type | percentage |
|---|---|---|---|
| Powder | Inorganic | Elastomer | 100% |
| Blend | Component | Elastomer + plastic | 90-10% to 10-90% |
| | | (when present) | |
| | Organic | Polymeric | 90-10% to 10-90% |
| | component | alloy + organic | |
| | | fiber | |
| | Organic + | Relationship between | 90-10% to 10-90% |
| | Inorganic | organic/inorganic | |
| | | components | |

Finally, the blend or mixture of powders (second two-component, also called two-component 2), formulated according to the above proportions, is duly deposited on a first layer of cyanoacrylate (first two-component, also called two-component 1), followed by successive and alternating layers of two-components 1 and 2. In particular , two-component 1 is always applied after removing the excess of the powder blend (two-component 2) (and this excess is reusable, increasing its yield and reducing its cost), assimilated by component 1, which is, in the amount it needs, without interference from the applicator, thus avoiding complicating dosimetries. The inventor suspects that two-component 1 assimilates more or less from two-component 2, depending on the subject they are touching, given numerous face-to-face tests.

The tests showed that the reaction times between the two two-components are short, with such time being around, at most, a few seconds.

Finally, and in order to prove the results proclaimed, specimens were submitted to structural and behavioral analyzes for plastic specimens, together with the IPT, according to the analyzes according to ASTM D695-15 standards (behavior of rigid plastics in compression ratio); ASTM D 2240-15e1 (Shore B hardness analysis); ASTM D638-14 (Stress Properties Analysis); and ASTM D1238-13 (flow index analysis). The results indicated below are reported from Test Report 1 113 432-203 of December 2019.

The tests were carried out comparing two identical specimens, taken from a vehicle bumper (formed from PP and EPDM), the first being for comparative purposes (undamaged), while the second (test effective) had a tear which was subsequently repaired from the adhesive composition according to the invention.

In the formulation of the adhesive composition used to repair this specimen,

TABLE 2

| | Rupture tension (MPa) ^{[1]} | | Rupture strength (N) ^{[1]} | |
|---|---|---|---|---|
| Specimen | Base material | Weld | Base material | Weld |
| 1 | 125.99 | 84.39 | 22034.73 | 14759.70 |
| 2 | 110.69 | 110.69 | 19358.22 - | 12385.38 |
| 3 | 133.92 | 133.92 | 23421.13 | 19977.89 - |
| 4 | 119.34 | 119.34 | 20871.89 | 16999.28 |
| 5 | 121.12 | 121.12 | 21182.44 | 18494.37 |
| Average | 122 ± 11 | 114 ± 23 | 21374 ± 1860 | 16523 ± 3739 |

the powder blend was formed by a polymeric origin component in the form of vulcanized rubber powder (recycled tire, with powder formation mechanically), mixed with an organic origin component in the form wheat flour (commercial product) as a single source for alloy organics and organic fibers.

For the repair of the bumper, the procedure of overlapping layers was used, directly on the damage, without patches or overlapping of accessory plates, as described above.

According to the results obtained from the above and below specified analyses, it was determined that, among other tests, the compressive resistance, indicated in rupture tension (MPa), practically the same results between the base material and the weld.

It should also be noted, in the same test, that the rupture tension required to break the wel [symbol] pture strength necessary to break the base material in specimen 2.

In relation to Shore hardness, the weld region of the specimen showed a hardness about 13% lower than the hardness of the comparison body. Specifically, the average Shore D hardness values for said base material were measured to be D/72±1, while the Shore D hardness in the weld resulted in D/62±1. Such a result is particularly important considering that, in the repair of a bumper, or any similar part, the weld zone must be sanded for later painting. If the Shore D resistance of the weld were higher than that of the plastic part (which does not occur) it would result in greater difficulty in sanding the weld than the plastic part, which would cause depressions in the part due to the excavation of the sandpaper on the sides of the weld, for this reason be harder than the part being repaired, forcing the subsequent application of corrective leveling masses, which reduces the useful life of these repairs, since such masses are fragile and crack very easily, in the daily use of vehicles, and, with the use of the composite in mesh, objective of this patent, such use of putties is unnecessary, since its sanding is as soft as that of the welded piece, in addition, its micronized grains allow a result after sanding compact and without craters, or holes, in addition to completely leveling with the part being repaired, thus, resulting in defined, not causing lateral excavations to the weld and completely dispensing with the use of such leveling masses, immediately passing to the works painting hours and, thus, increasing the useful life of repairs, significantly reducing the time required for such repairs, thus increasing the profitability of the workshops.

Another relevant feature of the invention resides in the final elasticity of the weld region, which makes the present adhesive composition particularly suitable for joining plastic materials, as reported in Table 3 below, where a result of a higher modulus of elasticity of the weld is observed in relation to that of the welded part, in the specimen 3.

In addition, the weld showed a fluidity index (g/10 min) slightly higher than twice the index (measured) obtained for the comparison body (base material).

As can be interpreted from the results reported here, one of the most important characteristics of the region repaired from the two-component adhesive composition, according to the present invention, is its malleability, allowing the piece to be bent, after repair, as it was bent before, when still intact and without damage, and its smooth, fast and level sanding, possible immediately after its application, significantly reducing repair times, which is radically opposed to the non-malleability, rigidity and high hardness for sanding resulting from welded regions from cyanoacrylate and other epoxy based glues known in the art.

Furthermore, in the same tests, analyzes were performed regarding the dimensional of the component particles of the powder blend, that is, both the particles of the organic component and the particles of the inorganic component. Such results confirm

TABLE 3

| | | Elastic |
|---|---|---|
| test region | Specimen | modulus (MPa) |
| base | 1 | 685.91 |
| material | 2 | 599.78 |
| | 3 | 519.10 - |
| | 4 | 624.33 |
| | 5 | 569.44 |
| | Average | 600 ± 77 |
| weld | 1 | 487.88 |
| | 2 | 453.07 |
| | 3 | 537.81 - |
| | 4 | 513.79 |
| | 5 | 314.16 |
| | Average | 461 ± 109 |

a broad distribution of particle sizes in accordance with the assumption of the present invention. In the aforementioned test, particles with sizes from an order of magnitude of a micron to an order of magnitude of millimeters were identified. Such a wide distribution is understood by the inventor as necessary and highly beneficial, since it allows the adhesive of the invention to adapt to any material being welded and to promote its rooting in the microscopic pores of the parts, allowing even greater anchoring power. In this way, and as a feature of the invention, the particles of the powder blend must be distributed within a range encompassing from particles with a diameter of 1 micron to 1 millimeter, and more in particular with a diameter from 6 microns to 0.1 millimeters.

This characteristic makes the present adhesive composition particularly suitable for welding plastic materials, without compromising the original plastic and elastic characteristics, not forgetting its auspicious performance, also, in thermoset or thermostable materials, which in turn, do not respond to processes of heat welding.

On the other hand, and in order to contemplate the efficiency of the present two-component adhesive composition, complementary tests were carried out, also with the IPT, in which the functional behavior was evaluated with other specimens, that is, including materials other than plastics.

Thus, and according to Test Report No. ¹ 120 876-203, completed on Nov. 17, 2020, specimens were considered, according to table 4, below:

TABLE 4

| | Identification |
|---|---|
| types of material | in the laboratory |
| aluminum on steel | LEL 188-20 |
| aluminum on aluminum | LEL 189-20 |
| rubber on aluminum | LEL 190-20 |
| plastic on plastic | LEL 191-20 |
| plastic on steel | LEL 192-20 |
| steel on steel | LEL 193-20 |
| rubber on Plastic | LEL 194-20 |
| plastic on aluminum | LEL 195-20 |

In these tests, specimens were formed from the union of individual pieces and different materials, in order to determine the effectiveness of the composite of the present invention in the union of different materials. Such trials were performed in accordance with ASTM D1002-10 (2019)—Standard Test Method for Apparent Shear Strength of Single-Lap-Joint Adhesively Bonded Metal Specimens by Tension Loading.

The results are reported in the Table below:

TABLE 5
Determination of shear strength

| | | | Rupture | Rupture | | |
|---|---|---|---|---|---|---|
| | width | Length | Strength | Tension | Failure | fault |
| Identification | (mm) | (mm) | (N) | (MPa) | type [1] | location |
| LEL 188-20 | 26.31 | 75.27 | 2856.91 | 1.443 | cohesive | Interface |
| LEL 189-20 | 27.37 | 63.83 | 2090.75 | 1.197 | cohesive | Interface |
| LEL 190-20 | 26.07 | 55.53 | 414.75 | 0.286 | Traction | external |
| LEL 191-20 | 24.55 | 49.96 | 899.64 | 0.733 | Traction | external |
| LEL 192-20 | 26.29 | 48.72 | 1132.55 | 0.884 | Traction | external |
| LEL 193-20 | 25.63 | 49.51 | 1954.55 | 1.540 | cohesive | Interface |
| LEL 194-20 | 27.89 | 43.39 | 403.85 | 0.334 | Traction | external |
| LEL 195-20 | 27.51 | 58.16 | 1097.13 | 0.686 | Traction | external |

[1] Some specimens suffered tensile failure due to the interface strength being higher than that of the polymeric substrate

As can be easily seen, several specimens showed failures outside the bonding region, that is, the rupture occurred in one of the materials of formation of the specimen, and not in the union of these by the adhesive composition in mesh.

According to the inventor, such highly efficient results are the result of a reaction sequence, which begins with the combination between cyanoacrylate and rubber, resulting in a thiocyanate, or sulfur cyanide, which, as soon as it is formed, acts in reaction with the fibers and the other organic polymers in the form of powder particles, initially interacting with the smaller particles and progressively with the larger particles. The polymer chains thus modified play an important role in joining or welding the pieces being glued. In addition, the inventor understands that the fibers and polymers also help in the positive results of compressive strength and shear strength, in addition to also guaranteeing the malleability of the joining region, as well as its immediate curing that gives rise to an immediate and high docility.

On the other hand, in ancillary information, preliminary tests pointed to unsatisfactory results, but also useful in terms of development, from the combination of cyanoacrylate only with fibers and organic polymers, when before, still at the beginning of the research, they were not combined with elastomers and plastics, also in powder form.

It is worth mentioning that in terms of quality control, the screen composition is quite constant in its results, even though several commercial brands of wheat flour, component of the powder blend, have been tested. In addition, wheat flours with and without additives were also tested, and the final result was always constant and consistent in terms of cohesion of the welded materials.

1. A two-component type adhesive composition, the first of the two components being a cyanoacrylate based glue, and wherein the second of the two components comprises a powder blend of polymeric origin components and organic origin components.

2. The adhesive composition, according to claim 1, wherein the polymeric origin component comprises an elastomer.

3. The adhesive composition, according to claim 2, wherein the polymeric origin component comprises natural or synthetic rubbers, preferably recycled.

4. The adhesive composition, according to claim 2, wherein the polymeric origin component further comprises a plastic polymer.

5. The adhesive composition, according to claim 4, wherein the plastic polymer component comprises ABS, PE, PS, PET or PP, preferably recycled.

6. The adhesive composition according to claim 1, wherein the organic origin component comprises an organic alloy material.

7. The adhesive composition according to claim 1, wherein the organic origin component of comprises an organic fiber material.

8. The adhesive composition according to claim 6, wherein the organic alloy material comprises gluten.

9. The adhesive composition, according to claim 6, wherein the alloy organic origin component comprises cellulose.

10. The adhesive composition, according to claim 6, wherein the alloy organic origin component comprises glucose.

11. The adhesive composition, according to claim 6, wherein the organic alloy material comprises wheat flour, corn flour, cornmeal or cassava flour.

12. The adhesive composition, according to claim 7, wherein the organic fiber material comprises starch.

13. The adhesive composition according to claim 1, wherein a proportion between the organic origin component in relation to the polymeric origin component is comprised between 10% and 90%.

14. The adhesive composition, according to claim 1, wherein said composition has a distribution of the powder blend particles from 1 mm to 1 micron, and preferably from 0.1 mm to 6 microns.
